(19) United States
(12) Patent Application Publication
(10) Pub. No.: US 2002/0185858 A1
(43) Pub. Date: Dec. 12, 2002

(54) World time converter for analog clock

(76) Inventors: Hiroaki Kitagawa, Tokyo (JP); Chiyoko Kitagawa, Tokyo (JP); Kaori Kitagawa, Tokyo (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/051,157

(22) Filed: Jan. 22, 2002

(30) Foreign Application Priority Data
May 21, 2001 (JP) 2001-151120
Jul. 10, 2001 (JP) 2001-208909
Oct. 29, 2001 (JP) 2001-330768

(51) Int. Cl. B42D 15/00

(52) U.S. Cl. 283/81

(57) ABSTRACT

A simple tool to know local time around the world that is applicable to analog watches or clocks. A transparent sticker with world major city marks printed converts an ordinary clock to a world clock only by being attached on the face of a clock. The sticker is attached according to a rule that the standard time city mark comes to the 12 o'clock position. On the sticker sheet, other city marks are aligned along a circumference according to their time differences based on their global geographical location. A transparent clock dial with a marker at 12 o'clock position serves the same function. The dial is placed over the clock face in such a manner the marker comes to the designated position according the city whose local time is wanted. The short hand is read according to the overlaid clock dial. A chart can be used to know where the marker should be placed.

### BACKGROUND OF THE INVENTION

1. Field of Invention

The present invention is directed to simple pieces to be applied on the face of an analog clock or watch, which enables to read the local time of world's major cities as opposed to the standard time set for the city where the person lives.

2. Description of the Related Art

In order to know the local time of world's major cities, some special mechanisms have been hitherto applied to analog watches or clocks themselves, such as a rotating disk or a ring that has a print of the world map or the major city names and moves along with the short hand. These mechanisms inside the clock have been rather complicated, thus, expensive and applicable only to one country or one time zone.

There has been also a way to know the local time of world major cities with a small card with a rotatable disk having a 24 hour-time-scale. Around the disk are city or area names printed on the base part of the card. A person first reads his standard time (Ts) with his watch or clock, then consult the card to see what local time it is in other areas around the world by adjusting the disk to his city name. Each hour division points the local time of the matching area on the card. Although the device is not complicated, a person still have to carry around the card. Also, the card, being composed of a board, a disk, and a pin, was not sufficiently simple.

### SUMMARY OF THE INVENTION

This invention provides a simple, universal way of converting an ordinary clock or watch to a multi-time world clock or watch without incorporating elaborate mechanisms on the clock or watch. Moreover, the converted multi-time clock can be easily returned to the original one if necessary or wanted.

According to the present invention, a transparent sticker with world major city marks printed converts an ordinary clock to a world clock only by being attached on the face of a clock. The sticker is attached according to a rule that the standard time city mark comes to the 12 o'clock position. On the sticker sheet, other city marks are aligned along a circumference according to their time differences based on their global geographical location. Each city mark position on the sticker represents the city's 12 o'clock location in the standard time frame. 12 o'clock is chosen as an easily understandable marker.

A clock with this sticker properly attached thereon is already a multi-time world clock as it is read in the following way. The city whose time is read on the standard way will be referred to as the “standard time city.” Suppose the standard time is EST in America, and a person wants to know the local time in Tokyo. If he reads the clock hands as he usually does, it is EST. If he reads the short hand assuming the Tokyo mark position on the sticker as its 12 o'clock position, then the time he reads is Tokyo local time. The long hand reading should be the same as EST. Accordingly, when he travels to Tokyo wearing a watch with this sticker attached, he does not have to adjust his clock to Tokyo time, and he can easily know what time it is both in New York and in Tokyo visually. Time difference calculation is unnecessary. All he needs is the invented sticker on his clock or watch.

If the person just wants to know some selected cities' local time, then he can peel off the only selected city marks from the sticker sheet and put them on at each designated position. In this case, because the sticker covers only a portion of the clock's face, the sticker film does not necessarily have to be transparent.

Since the ordinary clock is a 12-hour clock, it may not be easy to tell instantly if it is in the morning or in the afternoon for each local time. There is a rule for knowing this. ###### For those cities more than 12 hours behind or less than 12 hours ahead of the standard time city, if the short hand is in between 12 o'clock and the specific city mark position clockwise, and for those cities that are less than 12 hours behind or more than 12 hours ahead the specific city, if the short hand is in between 12 o'clock and the specific city mark counterclockwise, then the judgment for morning or afternoon coincides with that of the standard time city.

The same rule applies wherever one may go around the world on the condition that the standard time city mark should be always on the 12 o'clock position.

Wishing to know world local times, some people may hesitate to put a stickers on an elegant watch. For these people, there is a substitute as simple as the sticker using the same world time converting logics although they have to carry around the substitute of a sticker separately from the watch.

The substitute can be a card with a transparent clock dial having a marker, normally at 12 o'clock position. The clock dial may be either printed on a transparent card, or simply a circular hole around which time divisions and digits are printed along with a maker on a non-transparent card. The card preferably comes with a chart or a diagram which indicates where each area's 12 o'clock locates in the standard time frame. A person can find where to put the marker when he places the card over the watch face to know the local time of a city on the chart. The center of the transparent clock dial should come right on that of the watch. The short hand with the overlaid transparent clock dial gives a person the city's local time as he puts the 12 o'clock marker exactly on the city's designated position. The card of the present invention is also applicable worldwide by substituting the time difference chart of one standard time city with that of another city.

The morning or afternoon judgment of this card case can be done in the same manner as in the case of sticker.

### BRIEF DESCRIPTION OF THE DRAWINGS

FIG. 1 shows an example of the invented sticker design.

FIG. 2 shows an example of the actual invented sheet of sticker to be handed to each user, which contains the explanation of how to use the sticker as well.

FIG. 3 shows the sticker put on to a watch whose time now is ten o'clock and ten minutes in Tokyo, a standard time city in this case. The sticker design is the same as FIG. 1.

FIG. 4 shows the sticker of another design put on to a watch whose time now is three o'clock and forty-five minutes in Tokyo, a standard time city in this case as well.

FIG. 5 shows a clock with only selected city marks put on, New York, San Francisco, London, and Tokyo. It is now three o'clock and forty-five minutes in Tokyo just like FIG. 4.

FIG. 6 shows a transparent clock dial with the star marker at 12 o'clock location.

FIG. 7 shows a time difference chart which can go with the transparent clock dial indicating where the 12 o'clock star marker should be placed when the transparent clock dial card is placed over a clock face.

FIG. 8 shows an example of the transparent clock dial being placed over a clock face.

FIG. 9 shows another example of the transparent clock dial being laid over a clock face.

FIG. 10 shows an example of a card that includes the transparent clock dial, the time difference chart, and the explanation of how to use the card.

### DESCRIPTION OF THE PREFERRED EMBODIMENTS

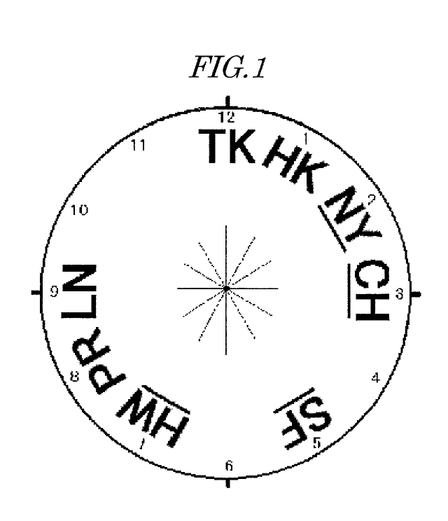

FIG. 1 shows an example of the invented sticker design. The sticker film should be transparent so that the clock's hands can be seen through when the sticker is applied to the face of a clock. The sticker can be peeled off along the circumference line. When being put on one's clock or watch, the center of the circle should be exactly on the center of one's clock or watch and the standard time city mark also should be on the 12 o'clock position in terms of angle. In this figure, each city's mark is abbreviated representing Tokyo for TK, Hong-Kong for HK, New York for NY, Chicago for CH, San Francisco for SF, Hawaii for HW, Paris for PR, and London for LN. Underlined cities are more than 12 hours behind from Tokyo time.

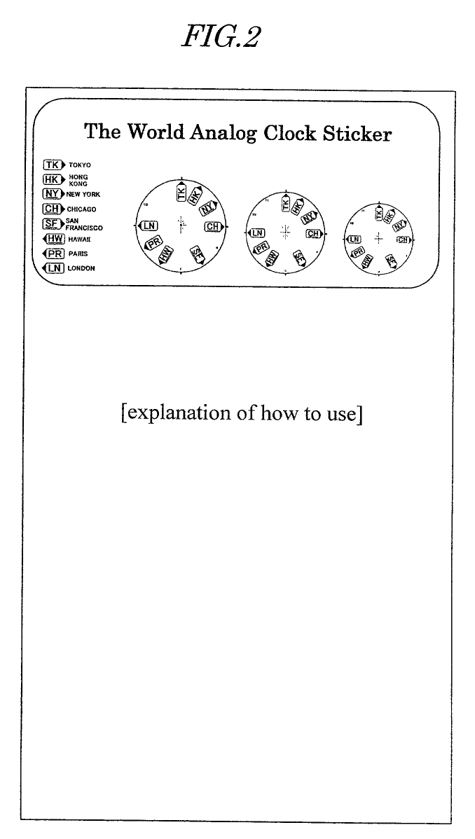

FIG. 2 shows an example of the actual invented sheet of sticker to be handed to each user, which contains the explanation of how to use the sticker as well. Assuming each user's clock or watch size differs one another, this sheet includes three different sizes of invented world clock stickers. The sticker sheet also includes individual city marks with half-cut lines around them so that users can choose only cities whose local time they want to know.

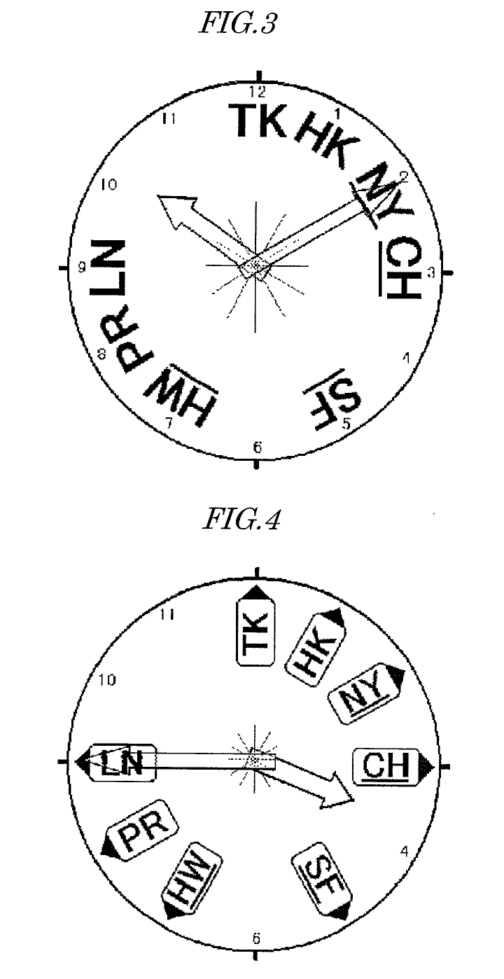

FIG. 3 and FIG. 4 are examples of actual application of the invented analog world clock sticker. In both cases, since the TK (Tokyo) mark is at their 12 o'clock position, standard time is Tokyo time. Here is the way of how to read other major cities' local time visually.

In FIG. 3, it is 10:10 A.M. in Tokyo. When the user wants to know New York's local time, the short hand is read supposing the NY mark position as its 12 o'clock. The long hand should be read in an ordinary way as in Tokyo. Therefore, in this case New York's local time is read as 8:10. The judgment of whether it is in the morning or in the afternoon in New York can be done by seeing if the short hand is within the area between 12 o'clock and NY mark clockwise. If it is within this area, then morning or afternoon in New York coincides with that of Tokyo. If not, the judgment reverses. In FIG. 3, the short hand is not in the above-mentioned area, so New York is in the afternoon. New York's local time is 8:10 P.M. In the same manner, San Francisco's local time can be read as 5:10 P.M. and Hawaii's local time is 3:10 P.M.

How to decide the area for the morning or afternoon judgment differs depending on whether or not the cities have more than 12 hours time difference from the standard time city. If the difference is more than 12 hours, the area from 12 o'clock to the wanted city mark must be clockwise, and if less than 12 hours, the area from 12 o'clock must be counterclockwise. With this in mind, London's local time can be read as 1:10 A.M. and Paris's 2:10 A.M. In FIG. 3 and FIG. 4 only cities more than 12 hours behind from Tokyo are marked with underlines to make the judgment easier.

In FIG. 4 it is 3:45 P.M. in Tokyo. By applying the same rule above, each city's local time can be known. Table 1 shows each city's local time read in this way for the case of FIG. 3 and FIG. 4.

TABLE 1

| | City Name | Case of FIG. 3 | Case of FIG. 4 |
|---|---|---|---|
| TK | Tokyo/Standard | 5/21 10:10 A.M. | 5/21 03:45 P.M. |
| HK | Hong Kong | 5/21 09:10 A.M. | 5/21 02:45 P.M. |
| NY | New York | 5/20 08:10 P.M. | 5/20 01:45 A.M. |
| CH | Chicago | 5/20 07:10 P.M. | 5/20 00:45 A.M. |
| SF | San Francisco | 5/20 05:10 P.M. | 5/20 10:45 P.M. |
| HW | Hawaii | 5/20 03:10 P.M. | 5/20 08:45 P.M. |
| PR | Paris | 5/21 02:10 A.M. | 5/21 07:45 A.M. |
| LN | London | 5/21 01:10 A.M. | 5/21 06:45 A.M. |

Although the way and the materials to produce the invented sticker is no more than ordinary stickers, the following functions or specifications should be attained to serve as an analog world clock sticker. (1) The plastic film must be clear or transparent when applied to the face of a clock or watch as a whole plastic disk so that the short and long hands can be seen through, but can be opaque when only selected city marks are put on to limited areas of the face. (2) The plastic film must be flexible enough to tightly adhere to the clock face that usually has some curvature. In other words, the film should not be too thick or rigid. The thickness and the kind of plastic should be chosen properly. (3) Because the invented sticker is not for permanent use, but is rather for temporary use, the adhesive or glue should not be too strong to be removed. Ideal adhesiveness should not be so weak as to be easily peeled off, and not so sticky as residuals can be left on the clock's glass or clear-plastic face. (4) Printing ink should be water resistant, or preferably covered with laminating thin clear film, so that the printed city marks will not wear away so easily.

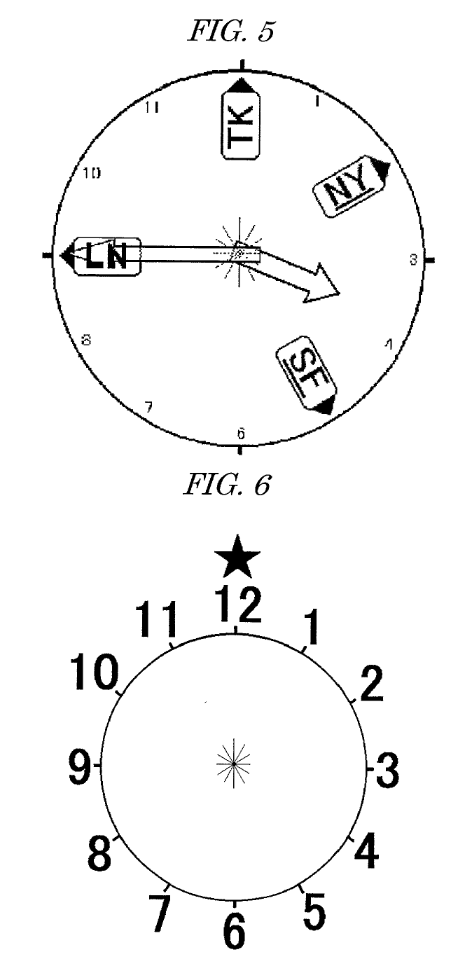

FIG. 5 is an example of only selected city mark stickers being put onto the clock's face with Tokyo as its standard time. Tokyo time now is three o'clock and forty-five minutes. If Tokyo is tacitly understood, then Tokyo mark can be left out.

Some cities around the world adopt “Summer Time,” for a certain period of the year. For those cities, an hour has to be added to the local time known by this invented sticker. For user's convenience, a table with city names and their summer time periods may be useful together with this invented analog world clock sticker.

In FIGS. 1 to 5, cities that have more than 12 hours time difference from Tokyo time are underlined for the convenience of the morning or afternoon judgment. (Underline can be some other mark.) This feature is specific for those who wish to set Tokyo time as his standard time. Except for this feature, the invented sticker design is applicable for anyone in any country around the world who wants to set his city's time as his standard time putting the sticker onto his watch with his city's mark at 12 o'clock position. In this sense, the invented sticker is universal.

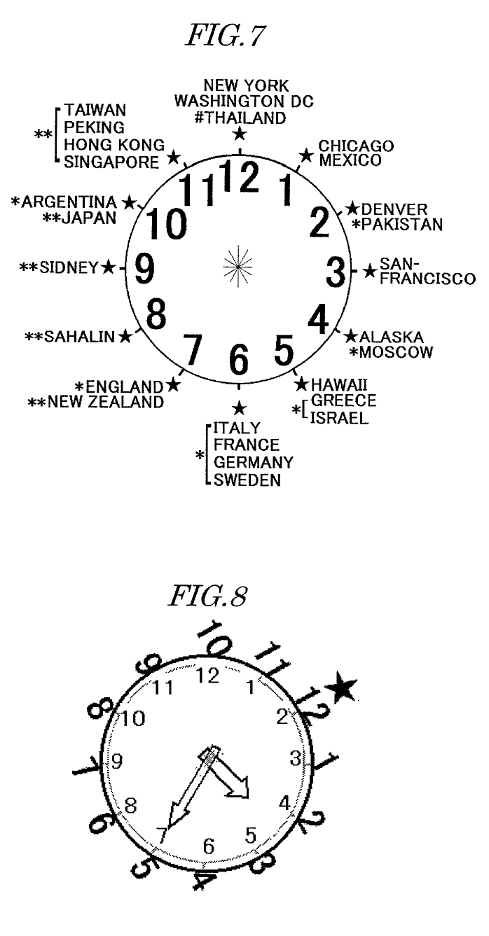

For those who hesitate to attach a sticker on their elegant clock or watch but wish to know local time of other cities in an easy instant way, there is another embodiment of world time converter which substitutes the sticker. FIG. 6 shows a card with a transparent clock dial having a marker usually by 12 o'clock. This transparent clock dial can be made of a whole clear resin sheet with prints or of any kind of sheet with a circular hole around which time divisions and digits are printed. A person can see the watch's dial and hands through the transparent clock dial. The transparent clock dial is placed over the face of the watch with the 12 o'clock marker at a corresponding position of the city whose local time is wanted. The corresponding position can be known from a chart like the one shown in FIG. 7, where some cities are marked with * or ** each indicating that those cities are less or more than 12 hours ahead of the EST. The # marked country, Thailand is exactly 12 hours ahead of the EST. Other city/countries with no mark are less than 12 hours behind the EST.

A person who wants to know city/country X's local time should first look into the time difference chart shown in FIG. 7 to locate the city/country X, then put the transparent dial card onto the face of the watch, having the 12 o'clock marker come to the location of the city X shown in the chart. The center of the transparent dial should stay right on that of his watch dial. FIG. 8 shows an example where the city X is Denver or any city in Pakistan. FIG. 8 shows that his time in the EST is 4:35 A.M. now. The short hand comes between 2 o'clock and 3 o'clock according to the overlaid dial. Thus, a person can know that the local time of Denver or Pakistan is 2:35. Applying the same rule as in the sticker for the morning or afternoon judgment, the person can know that it is 2:35 A.M. in Denver and 2:35 P.M in Pakistan.

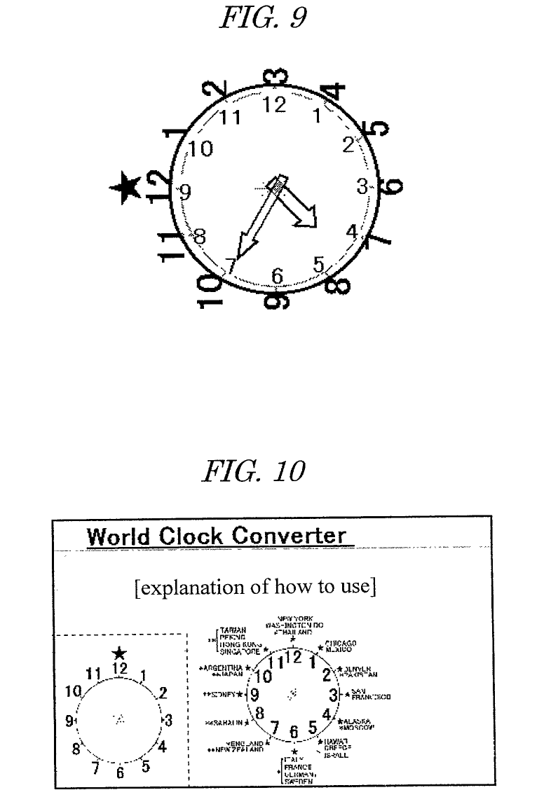

FIG. 9 shows another example, where the city X is Sidney, Australia, showing how this transparent dial card works. The watch is indicating its EST 4:35 P.M. A person who wants to know the local time of Sidney, Australia locates the Sidney's position at 9 o'clock from the chart, and puts the card marker onto 9 o'clock position of his watch. The short hand comes between 7 o'clock and 8 o'clock according to the overlaid dial, and Sidney's local time is found to be 7:35 A.M. applying the morning or afternoon judgment rule.

FIG. 10 is an example of a card of this invention. It contains the transparent clock dial at the lower left corner, the time difference chart at the lower center, and explanations of how to use is printed the other area of the card.

We claim:

1. A world clock/watch sticker comprising:
a sticker sheet defining a first side and a second side;
a first symbol representing a first city/country viewable from the first side; and
a second symbol representing a second city/country viewable from the first side,
wherein the sticker is to be attached onto a face of a clock/watch on the second side,
wherein an angular position of the first symbol and the second symbol around a center of the sticker sheet is determined by time difference between the first city/country and the second city/country.

2. The world clock/watch sticker according to claim 1, wherein the first symbol represents a standard time city and is positioned at 12 o'clock position.

3. The world clock/watch sticker according to claim 1, wherein the second symbol is positioned number of hours clockwise ahead relative to the first symbol on the sticker sheet according to the number of hours a second time of the second city/country is behind a first time of the first city/country.

4. The world clock/watch sticker according to claim 1, wherein the sticker sheet is transparent.

5. The world clock/watch sticker according to claim 1, wherein the second symbol is marked according to whether or not a second time of the second city/country is more than 12 hours ahead of or less than 12 hours behind a first time of the first city/country.

6. The world clock/watch sticker according to claim 5 wherein the second symbol is marked by one selected from an underline, a bracket, parentheses, a box or a different color.

7. The world clock/watch sticker according to claim 5 wherein the second symbol is marked by an underline.

8. The world clock/watch sticker according to claim 1, wherein the sticker is printed on a sheet in different sizes.

9. The world clock/watch sticker according to claim 1, wherein the sticker is printed on a sheet with additional symbols.

10. The world clock/watch sticker comprising: a plurality of symbols each of which representing a world major city/country to be attached onto a face of a clock/watch, wherein the angular position of the symbols around the center of the face of the clock/watch is determined by time difference between the each city.

11. The world clock/watch sticker according to claim 10, the symbols are marked according to whether or not the time of represented city/country is more than 12 hours ahead of or less than 12 hours behind a standard time.

14. A world clock/watch comprising:
a first symbol representing a first city/country; and
a second symbol representing a second city/country,
wherein an angular position of the first symbol and the second symbol around a center a clock/watch face is determined by time difference between the first city/country and the second city/country
wherein the second symbol is positioned number of hours clockwise ahead relative to the first symbol on the sticker sheet according the number of hours a second time of the second city/country is behind a first time of the first city/country.

13. The clock/watch according to claim 12, wherein the second symbol is marked according to whether or not a second time of the second city/country is more than 12 hours ahead of or less than 12 hours behind a first time of the first city/country.

14. A world clock/watch dial comprising:
a dial sheet; and
clock/watch digits printed around a circle on the dial sheet,
wherein the dial is to be placed on a face of a clock/watch,
wherein the face of the clock/watch is viewable through the dial, and
wherein an angular position of the dial on the face of the clock/watch is determined by time difference between a first city/country and a second city/country.

15. The world clock/watch dial according to claim 14, wherein the clock/watch is set according to the first city as a standard time city.

16. The world clock/watch dial according to claim 14, wherein the dial is angularly positioned number of hours clockwise ahead relative to the clock/watch according to the number of hours a second time of the second city/country is behind a first time of the first city/country.

17. The world clock/watch dial according to claim 14, wherein the dial sheet is transparent.

18. The world clock/watch dial according to claim 14, wherein the dial sheet is opaque and has an opening around which clock/watch digits are printed.

19. The world clock/watch dial according to claim 14, wherein the dial is printed on a sheet in different sizes.

20. The world clock/watch dial according to claim 14, further comprising a time difference chart.

21. A world clock/watch chart comprising:
a chart sheet;
a clock/watch digits printed on the chart sheet;
a first symbol representing a first city/country printed at a position corresponding to one of the clock/watch digits; and
a second symbol at a position corresponding to one of the clock/watch digits;
wherein the second symbol is positioned number of hours clockwise ahead relative to the first symbol on the chart according to the number of hours a second time of the second city/country is behind a first time of the first city/country.

22. The world clock/watch chart according to claim 21, wherein the first symbol represents a standard time city and is positioned at 12 o'clock position.

22. The world clock/watch chart according to claim 21, the second symbol is marked according to whether or not a second time of the second city/country is more than 12 hours ahead of or less than 12 hours behind a first time of the first city/country.

24. The world clock/watch chart according to claim 21, wherein the second symbol is marked by one selected from an underline, a bracket, parentheses, a box or a different color.

25. The world clock/watch chart according to claim 21, wherein the second symbol is marked by an underline.

26. The world clock/watch chart according to claim 21, further comprising a transparent clock/watch dial.
